(19) United States
(12) Patent Application Publication
(10) Pub. No.: US 2015/0363568 A1
(43) Pub. Date: Dec. 17, 2015

(54) SYSTEMS AND METHODS FOR ASSESSING PATIENT READMISSION RISK AND SELECTING POST-ACUTE CARE INTERVENTION

(71) Applicant: RightCare Solutions, Inc., Hillsborough, NJ (US)

(72) Inventors: Michael W. MILO, Willow Grove, PA (US); Matthew TANZER, Philadelphia, PA (US); Eric HEIL, Pipersville, PA (US)

(21) Appl. No.: 14/742,454

(22) Filed: Jun. 17, 2015

Related U.S. Application Data
(60) Provisional application No. 62/013,409, filed on Jun. 17, 2014.

(51) Int. Cl. G06F 19/00

(52) U.S. Cl. CPC G06F 19/3431

(57) ABSTRACT

Techniques for determining and outputting post-acute care recommendations that use information that is available when a patient is admitted, which is obtained through patient questionnaires and automatically-extracted patient history data, to determine a risk score and/or recommend post-acute care. Such techniques may be incorporated into systems, methods and computer program products for determining and outputting post-acute care recommendations based upon readmission risk scores. For example, a sample process for determining and outputting recommendations may include receiving admission data relating to a patient, receiving assessment information regarding the patient, determining a readmission risk score for the patient, determining a post-acute care recommendation for the patient based on the readmission risk score and one or more patient covariates, and outputting the post-acute care recommendation.

### CROSS-REFERENCE TO RELATED APPLICATIONS

This application depends from and claims priority benefit to U.S. Provisional Application Ser. No. 62/013,409, filed Jun. 17, 2014 and entitled, “Systems and Methods for Assessing Patient Readmission Risk and Selecting Post-Acute Care Intervention”, which is incorporated herein by reference in its entirety.

### BACKGROUND

Readmission risk assessment is an increasingly important aspect of hospital operations. Hospitals and other medical institutions have a significant financial incentive to reduce the number of patients that are readmitted within 30 days of discharge.

Conventional solutions assess the risk of readmission for a patient using regression models, support vector machines, or Bayesian statistics. However, such solutions have relied on data that is only available when a patient is discharged and/or is limited to a particular patient demographic. In addition, conventional solutions have failed to incorporate the use of post-acute care interventions to further improve patient outcomes.

### SUMMARY

In a first sample embodiment, a method may include: receiving admission data relating to a patient; receiving assessment information regarding the patient; determining a readmission risk score for the patient; determining a post-acute care recommendation for the patient based on the readmission risk score and one or more patient covariates; and outputting the post-acute care recommendation.

Alternatively or additionally, the method as described in the first sample embodiment may further include: outputting the readmission risk score; and receiving initial feedback regarding the readmission risk score prior to determining the post-acute care recommendation, wherein determining the post-acute care recommendation is further based on the initial feedback, and wherein the initial feedback comprises at least an initial recommendation or an alternate recommended option for the patient.

Alternatively or additionally, the method as described in the first sample embodiment may further include: receiving an outcome regarding post-acute care of the patient subsequent to outputting the post-acute care recommendation; and updating a database containing the assessment information.

Alternatively or additionally, the one or more patient covariates as described in the first sample embodiment may include a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

Alternatively or additionally, in the first sample embodiment, determining the readmission risk score may include determining a conditional probability of readmission based on a set of covariates relative to a population risk.

Alternatively or additionally, in the first sample embodiment, determining the readmission risk score may include determining the readmission risk score based on the patient's history and other patient outcomes.

In a second sample embodiment, a system may include a processing device and a non-transitory, computer-readable storage medium in operable communication with the processing device. In the second sample embodiment, the non-transitory, computer-readable storage medium may include one or more programming instructions that, when executed, cause the processing device to: receive admission data relating to a patient; receive assessment information regarding the patient; determine a readmission risk score for the patient; determine a post-acute care recommendation for the patient based on the readmission risk score and one or more patient covariates; and output the post-acute care recommendation.

Alternatively or additionally, in the second sample embodiment, the non-transitory, computer-readable storage medium may further include one or more programming instructions that, when executed, cause the processing device to output the readmission risk score and receive initial feedback regarding the readmission risk score prior to determining the post-acute care recommendation, wherein determining the post-acute care recommendation is further based on the initial feedback, and wherein the initial feedback comprises at least an initial recommendation or an alternate recommended option for the patient.

Alternatively or additionally, in the second sample embodiment, the non-transitory, computer-readable storage medium may further include one or more programming instructions that, when executed, cause the processing device to receive an outcome regarding post-acute care of the patient subsequent to outputting the post-acute care recommendation and update a database containing the assessment information.

Alternatively or additionally, in the second sample embodiment, the one or more patient covariates may include a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

Alternatively or additionally, in the second sample embodiment, the one or more programming instructions that, when executed, cause the processing device to determine the readmission risk score may include one or more additional programming instructions that, when executed, cause the processing device to determine a conditional probability of readmission based on a set of covariates relative to a population risk.

Alternatively or additionally, in the second sample embodiment, the one or more programming instructions that, when executed, cause the processing device to determine the readmission risk score may include one or more additional programming instructions that, when executed, cause the processing device to determine the readmission risk score based on the patient's history and other patient outcomes.

In a third sample embodiment, a computer program product may include one or more programming instructions that, when executed by a processing device, cause the processing device to: receive admission data relating to a patient; receive assessment information regarding the patient; determine a readmission risk score for the patient; determine a post-acute care recommendation for the patient based on the readmission risk score and one or more patient covariates; and output the post-acute care recommendation.

Alternatively or additionally, in the third sample embodiment, the computer program product may further include one or more programming instructions that, when executed by the processing device, cause the processing device to output the readmission risk score and receive initial feedback regarding the readmission risk score prior to determining the post-acute care recommendation, wherein determining the post-acute care recommendation is further based on the feedback, and wherein the initial feedback comprises at least an initial recommendation or an alternate recommended option for the patient.

Alternatively or additionally, in the third sample embodiment, the computer program product may further include one or more programming instructions that, when executed by the processing device, cause the processing device to receive an outcome regarding post-acute care of the patient subsequent to outputting the post-acute care recommendation and update a database containing the assessment information.

Alternatively or additionally, in the third sample embodiment, the one or more patient covariates comprise a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

Alternatively or additionally, in the third sample embodiment, the one or more programming instructions that, when executed by the processing device, cause the processing device to determine the readmission risk score may include one or more additional programming instructions that, when executed by the processing device, cause the processing device to determine a conditional probability of readmission based on a set of covariates relative to a population risk.

Alternatively or additionally, in the third sample embodiment, the one or more programming instructions that, when executed by the processing device, cause the processing device to determine the readmission risk score may include one or more additional programming instructions that, when executed by the processing device, cause the processing device to determine the readmission risk score based on the patient's history and other patient outcomes.

### BRIEF DESCRIPTION OF THE FIGURES

FIG. 1 depicts diagram of an illustrative system for assessing patient readmission risk and selecting post-acute care intervention according to an embodiment.

FIG. 2 depicts a block diagram of an illustrative network for assessing patient readmission risk and selecting post-acute care intervention according to an embodiment.

FIG. 3 depicts a flow diagram of an illustrative method for assessing patient readmission risk and selecting post-acute care intervention according to an embodiment.

FIG. 4 depicts a block diagram of illustrative internal hardware that may be used to contain or implement program instructions, such as the process steps discussed herein, according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processing device and a tangible, computer-readable memory or storage device. The memory may contain programming instructions that, when executed by the processing device, cause the processing device to perform one or more operations. Examples of electronic devices include personal computers, supercomputers, gaming systems, televisions, mobile devices, medical devices, recording devices, and/or the like.

A “mobile device” refers to an electronic device that is generally portable in size and nature, or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, portable medical devices, and the like.

A “computing device” is an electronic device, such as a computer, a processing device, a memory, and/or any other component, device, or system that performs one or more operations according to one or more programming instructions.

The present disclosure relates generally to systems and methods that use information that is available when a patient is admitted, which is obtained through patient questionnaires and automatically-extracted patient history data, to determine a risk score and/or recommend post-acute care. The systems and methods described herein are configured to recommend post-acute care that is optimized for a particular patient population and/or subgroup. The systems and methods described herein are capable of receiving information about outcomes regarding patient care. As such, the systems and methods may improve their predictions over time. Such systems and methods described herein differ from conventional systems because they use specific patient covariates, extensibility, and performance at admission, and iteratively improve scoring algorithms as new data becomes available.

Various operations performed by the systems and methods described herein may include, but are not limited to, storing of de-identified patient encounter data in a historical data system at a hospital level, using patient data extracts to incorporate information from outside sources such as census data and social media, incorporating data sources into a probabilistic model for calculating patient readmission risk (PRR) relative to a general patient population, identifying, clustering, and assigning patients to logical subgroups within a particular population, communicating PRR to case managers (CM) and intervention personnel, communicating and storing CM feedback during a patient risk assessment, incorporating PRR, patient group, and CM feedback into a recommendation for optimized post-acute care (PAC) acuity and cost, communicating patient data and risk assessment data to a PAC facility, monitoring and storing outcomes data from a patient and PAC facility feedback, and incorporating outcomes data into a historical data model over time for the purpose of improving PRR prediction and PAC referrals.

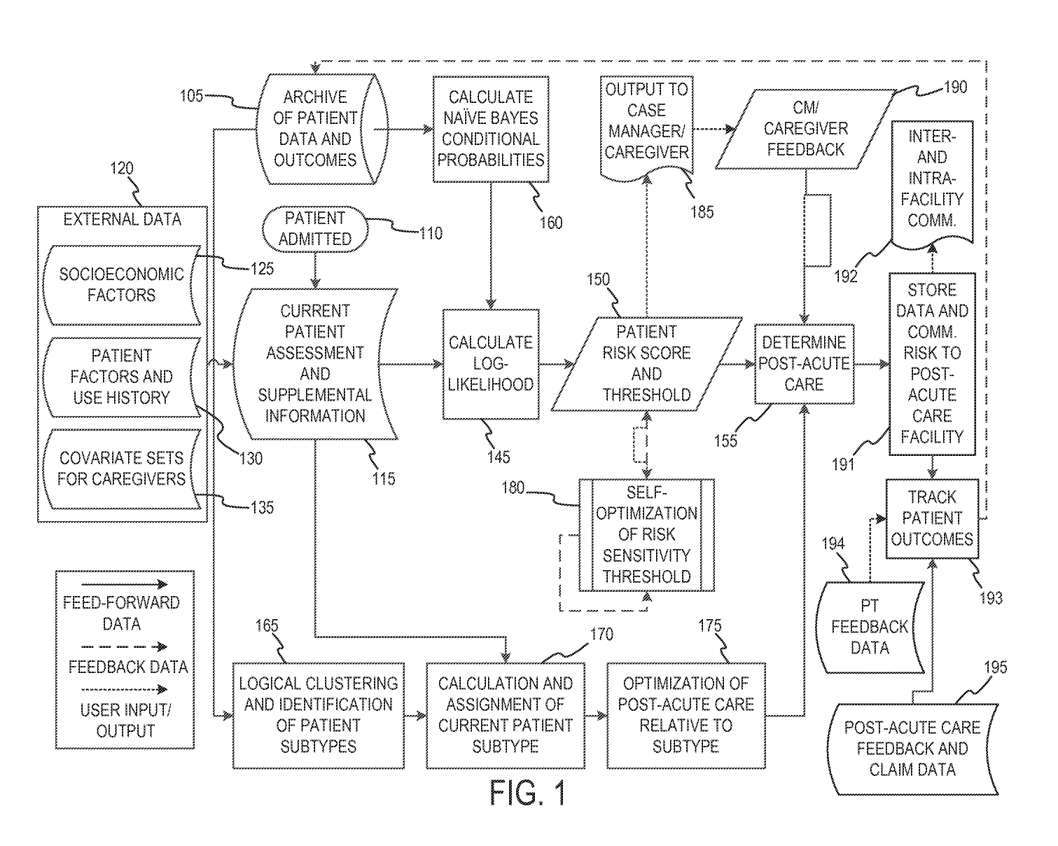

FIG. 1 depicts various aspects of an illustrative system according to an embodiment. An archive 105 of patient data and outcomes may be compiled to serve as training data for various machine learning algorithms involved in the system. The archive 105 may be referenced from a readmission risk subprocess and a patient grouping subprocess.

When a patient is admitted 110, the patient is assessed 115. Assessment 115 may generally include a method for modeling risk that relies on an input of factors that positively predict readmission risk and a need for acuity of care. The various factors may include a set of covariates. Illustrative factors include, but are not limited to, a patient's current cognition status, a patient's current walking ability, care availability at a patient's place of residence, the type of caregiver available at a patient's place of residence, home responsibility of patient, a patient's self-assessed health rating, a number of co-morbid conditions, a depression screening status, a loss-of-pleasure screening status, a patient's length of stay, a patient's age, a patient's likelihood to have self-care problems, a patient's continence, a patient's ability to bath, a patient's ability to dress themselves, current or history of substance abuse, and a patient's income. In addition, data used for the assessment 115 may be culled from external data sources 120, including, but not limited to, socioeconomic factors 125, patient factors and use history 130, covariate sets for caregivers 135, census data, mental health (including early psychosis) screening results, behavioral information such as drug use, social media information, and/or the like. Illustrative factors may include, but are not limited to, patient zip-code, home value, house heating source/fuel, housing tenure, housing occupancy, gross rent, gross rent as percent of household income, number of bedrooms, number of rooms, percent of homes lacking complete kitchen facilities, percent of homes lacking plumbing facilities, percent of families and people whose income in past 12 months is below the poverty line, ancestry origin, city, disability status of the civilian non-institutionalized population, employment status, marital status, mortgage status, number of grandparents living with own grandchildren under 18 years old, race, school enrollment, selected monthly owner costs as percent of household income, housing type, vehicle availability, years in current home, number of different living addresses in past 12 months, year of entry into the US, year of current home structure, percent renter occupied, educational attainment, median household income, median home prices, percent of residents foreign born, crime rates (such as murder, rape, robberies, assaults, burglaries, thefts, auto thefts, and arson), number of law enforcement officials per 1000 residents, unemployment rate, most common employment industry, average temperature, average precipitation, average snowfall, air quality index (AQI), and a number of grocery stores per 10000 residents.

In various embodiments, the assessment 115 may be performed on a set of covariates that are predictive of patient outcomes or the need for post-acute care. For a patient p, these covariates comprise a semi-structured set of key-value pairs (KVP's) for a given encounter E. The KVP variable may contain nested KVP variables, such that all applicable data about a patient is captured in an easily-indexed format. A partial example is shown below: E={‘id’:987654, ‘patientid’:123456, ‘age’:52, ‘weight’:210, ‘gender’:male, ‘diagnoses’:{‘admitting diagnosis’:‘244.9’, ‘principal diagnosis’:‘255.0’, ‘other diagnoses’:[‘249.5’, ‘366.41’, ‘278.0’]}, ‘admit date’:‘2014-01-15 13:02’ . . . }.

In various embodiments, the information may be used to assign the patient a readmission risk score 150 and/or a post-acute care determination 155. In some embodiments, the risk score 150 may be determined, for example, by a nested feedback Bayesian statistics algorithm 160, which may be used to determine an optimal threshold 150 for risk detection at a specific facility. Bayesian statistics relies on Bayes' Law:

$$P ( B \vert A ) = \frac{P ( A \vert B ) P ( B )}{P ( A )}$$

where the probability P(B|A) is the posterior distribution for the parameter B, probability P(B) is a prior distribution for the desired output parameter B, and probability P(A|B) is typically a likelihood function of observations A given B. Such Bayesian models may incorporate historical data to establish a more appropriate prior distribution in order to calculate posterior probabilities. As additional data is generated, patient outcomes are fed back into the model and the prediction of posterior probabilities is refined iteratively over time. In Bayesian statistics, this process is referred to as ‘sequential updating’ or ‘sequential analysis’, and has been applied to numerous other fields such as drug and vaccine safety. In this case, the observations A are a set of covariates predictive of readmission, and P(B) is a nonparametric distribution of readmission risk. In some embodiments, the patient may also be assigned 170 to a logical cluster based on the patient's data, which may also influence the determination 155 of post-acute care. Logical clusters and patient groups may be determined 165 using archived patient data and outcomes data using one or more processing techniques. For example, a processing technique may include clustering approaches such as K-means, mixture models, expectation maximization, and other classification algorithms. For example, a subset of quantitative encounter variables E_{[v1,v2 . . . vN]} may be described as a vector x having N dimensions. Each of M historical encounters could be so formatted to form an M by N set of vectors X. Given a target number of patient classes K, a K-means algorithm would attempt to classify all encounters x^{[i]} within X into each class. This algorithm (which uses a specific application of expectation maximization) sets target mean values for each cluster centroid in the N-dimensional space. Each data point x^{[i]} is assigned to its nearest centroid using any one of several distance computations (Euclidian, Manhattan, Mahalanobis, etc.). After this assignment, the centroid locations are recalculated, and all points are reassigned—this iterative process continues until the algorithm converges and stabilizes to a user-specified degree.

Additionally, patients may be assigned 170 to groups using hierarchal algorithms such as decision trees, nearest neighbors, and Bayesian statistical clustering. For example, implementation of a hierarchical clustering algorithm would also operate within the (above-defined) N-dimensional space, wherein the distances between data points determine similarity. At the lowest level, patients would be matched to their most similar (nearest neighbor) patient(s) within the historical population. As the similarity measure increases, the clusters grow and eventually combine. At the highest level, all patients are grouped within an M-sized cluster; at lower levels, granularity increases as the system branches into additional clusters. Because the logical clusters may be determined from the archived patient data and outcomes, which may include patient referral and discharge destination history, a patient's post-acute care intervention can be optimized 175 and predicted based on histories of similar patients at a particular facility.

Data may be output 185 to one or more case managers, one or more care givers, one or more post-acute care facilities, and/or the like. The various case managers, care givers, post-acute care facilities and/or the like may be provided with an ability to communicate 192 with each other regarding patient care and/or provide feedback 190. Outcomes of patient care may also be tracked 193 and/or stored 191 in a database or the like, as described in greater detail herein. The outcomes, along with patient feedback data 194 and/or post-acute care feedback and claim data 195 may be placed in the archive 105 for future incremental updates to the risk assessment and post-acute care algorithms.

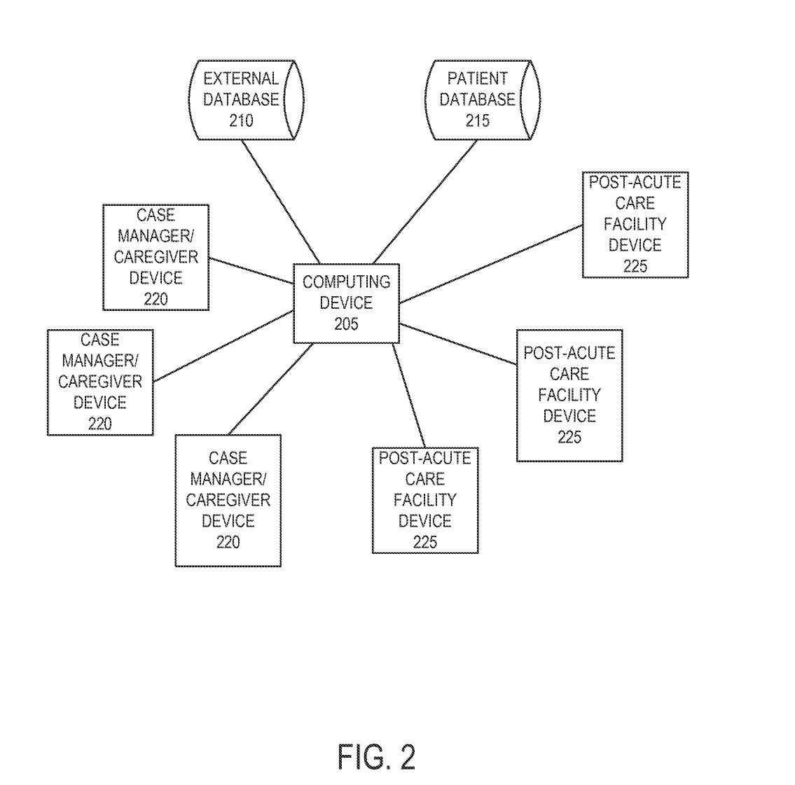

FIG. 2 depicts a block diagram of the various illustrative components that may be used to assess patient risk and select post-acute care intervention according to an embodiment. In some embodiments, the components disclosed herein with respect to FIG. 2 may be arranged in a network or similar configuration. Thus, the various components may be interconnected with one or more networking devices and may use any networking protocol now known or later developed. For example, the various components disclosed herein may be interconnected via the Internet, an intranet, a wide area network, a metropolitan area network, a local area network, an internet area network, a campus area network, a virtual private network, a personal network, and/or the like. The network may include a wired network or a wireless network. Those having ordinary skill in the art will recognize various wired and wireless technologies that may be used for the network without departing from the scope of the present disclosure.

In various embodiments, the network may include one or more computing devices 205, one or more patient databases 215, one or more case manager/caregiver devices 220, and/or one or more post-acute care facility devices 225. Additional or fewer devices may also be included within the network without departing from the scope of this disclosure. In some embodiments, the network may permit access to one or more external databases 210.

In various embodiments, the computing device 205 may generally be a central device to which at least one other component connects. The computing device 205 may be any type of computing device such as, for example, a personal computer, a server computer, a workstation, and/or the like. In some embodiments, the computing device 205 may be a plurality of computing devices that interoperate.

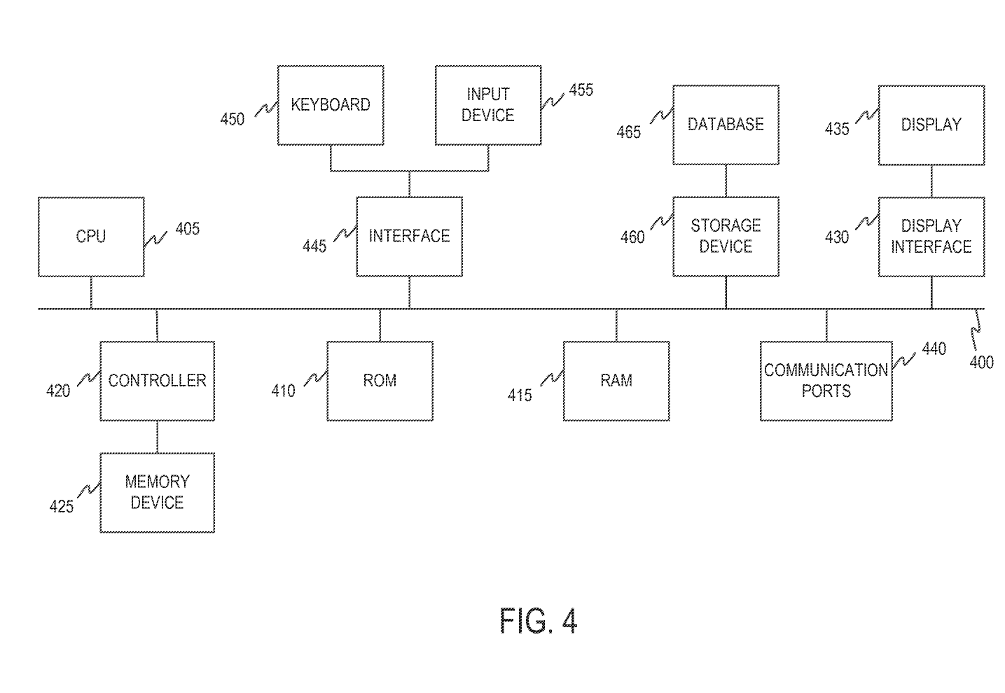

The computing device 205 may generally contain any hardware and/or software necessary for carrying out at least the various processes described herein. Illustrative hardware is described herein with respect to FIG. 4. In some embodiments, the computing device 205 may contain programming instructions in the form of software modules, where each module is configured to carry out at least a portion of the various processes described herein. For example, an assessment module may be used to complete the various processes for completing a patient assessment and obtaining supplemental information. In another example, one or more calculation modules may be used to determine various probabilities and/or patient risk scores, as described in greater detail herein. In yet another example, a tracking module may be used to track patient outcomes, obtain caregiver feedback, and/or the like, as described in greater detail herein.

In various embodiments, the computing device 205 may be configured to receive one or more inputs from a user. For example, a user may provide one or more inputs incorporating patient covariates, assessment information, supplemental information, and/or the like, as described in greater detail herein. In some embodiments, the computing device 205 may be configured to provide information to a user. Illustrative information may include, but is not limited to, post-acute care determination data, patient outcomes data, calculation results, and/or the like.

In various embodiments, the computing device 205 may be configured to communicate with one or more databases, such as, for example, the external database 210 and the patient database 215. In some embodiments, the one or more databases 210, 215 may be stored within the computing device 205. In other embodiments, the one or more databases 210, 215 may be stored within standalone devices separate from the computing device 205. For example, in some embodiments, the one or more databases 210, 215 may be located at an offsite facility, whereas the computing device 205 is located at a patient care facility such as a hospital or the like.

The external database 210 may generally be any type of database now known or later developed. Thus, the term “external” as used in this context is merely descriptive and is non-limiting. In some embodiments, the external database 210 may generally contain external data, such as the external data sources 120 (FIG. 1). Such external data sources may include socioeconomic data sources, patient factor data sources, patient use history data sources, covariate set data sources, and/or the like. For example, the external database 210 may be publically available databases such as census.gov, local property tax records, American Housing Survey (http://www.census.gov/programs-surveys/ahs/), national weather service, Center for Medicare and Medicaid Services, and/or geolocation mapping websites. The external database 210 may also be licensed or purchased data from third-party providers such as zillow.com, trulia.com, city-data.com, weather.com, google.com, twitter.com, facebook.com, and/or the like.

The patient database 215 may generally be a database containing patient-related information that may be used for one or more of the functions described herein. For example, patient data from the patient database 215 may be used to assess a patient, identify patient subtypes, calculate and optimize patient subtypes, determine a patient risk score, determine post-acute care, and/or the like. In addition, various feedback data, such as from the patient, a case manager, or a caregiver may be stored in the patient database 215 for future use, as described in greater detail herein. Illustrative factors in the patient database 215 may include, but are not limited to, diagnosis codes, procedure codes, medication lists, laboratory results, and/or vital signs.

The case manager/caregiver device 220 and the post-acute care facility device 225 may generally be devices that are used by the case manager/caregiver and post-acute care facility, respectively, to communicate with the computing device 205, receive information, provide information, and/or the like, as described in greater detail herein. Thus, for example, a case manager/caregiver may receive information from the computing device 205 about a patient that is to be discharged from an acute care facility to their care and/or provide feedback regarding the patient's progress after discharge from the acute care facility. The case manager/caregiver device 220 and/or the post-acute care facility device 225 may be, for example, an electronic device such as a computing device or a mobile device, as described in greater detail herein.

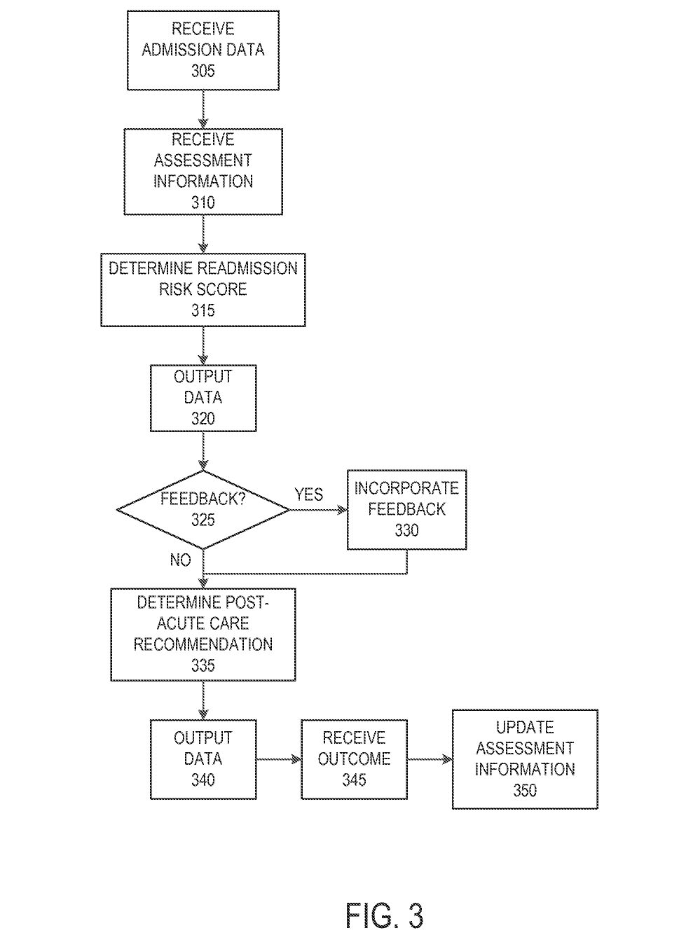

One or more of the devices described with respect to FIG. 2 may be used, either alone or in combination, to carry out one or more processes described in FIG. 3. FIG. 3 depicts an illustrative method for reassessing patient readmission risk according to an embodiment. In some embodiments, the processes described with respect to FIG. 3 may be embodied within a computer program product. The method may include receiving 305 admission data. The admission data may generally be data relating to a patient that is admitted to an acute care facility. The admission data may be received 305 from any source, such as, for example, directly from a patient, from a patient's representative, from a caregiver, from an acute care facility employee, from a database (such as the external database 210 or the patient database 215 described with respect to FIG. 2), and/or the like. In some embodiments, the admission data may include a patient's street address, a patient's city, a patient's zip-code, a patient's insurance information, a number of patient emergency department visits in past 12 months, a number of prior hospital admission stays in past 12 months, a hospital admitting service unit (orthopedic, cardiac, general med/surg, ICU, etc.), a patient's bed location, a patient's date of birth, a date of admission, and/or a particular time of admission.

The method may further include receiving 310 assessment information such as one or more patient covariates. The assessment information may generally be related to a patient assessment when a patient is admitted to a health care facility such as an acute care facility, as described in greater detail herein. Similar to the admission data, the assessment information may be received 310 from any source, such as, for example, directly from a patient, from a patient's representative, from a caregiver, from an acute care facility employee, from a database (such as the external database 210 or the patient database 215 described with respect to FIG. 2), and/or the like.

In various embodiments, a readmission risk score may be determined 315 based on the admission data, the assessment information, and/or other information or data, such as, for example, information or data described herein. Determining 315 the readmission risk score may include determining the score by, for example and without limitation, a nested feedback Bayesian statistics algorithm. Thus, in some embodiments, the score may be determined 315 by calculating a conditional probability of readmission given a set of covariates X, relative to a population risk R. Such a model may be similar to a Naïve Bayes algorithm and may be adapted to include a use of log-likelihood calculations for robustness against partial or missing data, and an incorporation of patient outcome feedback into a training algorithm to improve predictive power over time. The calculation of patient risk may be performed through a log-likelihood approach to the Naïve Bayes algorithm, which is typically used as a binary classifier and predictive modeling tool. In such a model, predictive covariates X are used to predict some output, Y through Bayes' theorem (shown above in [0017]). Adapted for use in a predictive model for readmission Y, the equation instead becomes:

$$P ( Y \vert X ) = \frac{P ( X \vert Y ) P ( Y )}{P ( X )}$$

where X is a set of covariates denoted [X₁, X₂ . . . Xᵢ . . . X_{N}]. For a given covariate Xi, the formulation of the posterior probability is straightforward: P(Y|Xᵢ)=P(Xᵢ|Y)P(Y)/P(X). The likelihood function reduces to:

$$P ( Y \vert X ) = \frac{LH ( X \vert Y ) P ( Y )}{P ( X )} = \frac{{\prod }_{i = 1}^{N} P ( {X}_{i} \vert Y ) P ( Y )}{{\prod }_{i = 1}^{N} P ( {X}_{i} )}$$

A key component of the calculation may be whether the patient is more or less at risk of readmission than other patients from the same hospital system. To this end, log-likelihood may be incorporated using a system's overall readmission risk as a baseline. By calculating a patient's individual risk R, it is possible to obtain a patient's relative risk (on a logarithmic scale) to a known patient population:

R=ln(P(Y|X)/P(Yₕₒₛₚᵢₜₐₗ))

Applying this to the likelihood functions in Bayes' theorem, the calculation for each covariate would become Rᵢ=ln(P(Y|Xᵢ)/P(Yₕ)), and the patient's overall risk relative to a specific population would be:

$$R = {\sum }_{i = 1}^{N} ln ( P ( Y \vert {X}_{i} ) / P ( {Y}_{h} ) )$$

This stems logically from the idiom that if a covariate elevates a patient's risk relative to the population, the log-score for that covariate is positive. If the converse is true, the score for that covariate would be negative. A positive overall score would indicate an elevated overall risk relative to a specific population. By omitting the scalar term P(Yₕ), log-likelihood scoring would be incorporated into a comparison between the probability of readmission vs. the probability of no readmission; the larger of the two being the classifier for that specific patient.

Data relating to the readmission risk score may be output 320 for potential review. For example, data may be output 320 to an acute care provider, a case manager, a caregiver, and/or the like and a determination 325 may be made as to whether initial feedback has been received from a respondent. For example, the feedback may include an initial recommendation or, if an initial recommendation is not available or appropriate for a specific situation or patient, one or more alternate options may be included in the feedback. If feedback has been received, the feedback may be incorporated 330 with the risk score to determine 335 a post-acute care recommendation. If feedback has not been received, the post-acute care recommendation may be determined 335 without such feedback. In some embodiments, it may be determined 325 that no feedback has been received if a respondent indicates he/she has no feedback. In other embodiments, it may be determined 325 that no feedback has been received if a respondent does not respond to the output 320 of data within a particular period of time.

The determination 335 of post-acute care recommendation may generally be completed based on the readmission risk score, previous post-acute care outcomes, outcomes of similar patients, feedback, and/or the like. As previously described herein, the post-acute care recommendation may include instructions for one or more persons to complete and/or report regarding post-acute care once the patient is discharged from the post-acute care facility.

In various embodiments, data relating to the patient risk score and/or the post-acute care recommendation may be output 340. The data may generally be output to an acute care provider, a case manager, a caregiver, a post-acute care provider, a patient, a patient's representative/family member, and/or the like such that the individual receiving the data can carry out the post-acute care instructions.

After the patient has been discharged and sufficient time has passed for the patient to complete and/or receive the recommended post-acute care, an outcome of the post-acute care may be received 345. The outcome may generally include any information regarding the type of post-acute care received by the patient, whether the patient complied with the recommendations that were output 340, whether a case manager complied with the recommendations that were output, whether additional care was received, and/or the like. The outcome data may generally be received 345 from any entity, including, but not limited to, the patient, a caregiver, a case manager, and/or the like.

In various embodiments, the assessment information may be updated 350 for future use based on the risk score, the determined 335 post-acute care, various feedback that has been received, and/or the like. Such information may be updated in a database, such as the database described in greater detail herein.

FIG. 4 depicts a block diagram of illustrative internal hardware that may be used to contain or implement program instructions, such as the process steps discussed herein, according to various embodiments. A bus 400 may serve as the main information highway interconnecting the other illustrated components of the hardware. A CPU 405 is the central processing unit of the system, performing calculations and logic operations required to execute a program. The CPU 405, alone or in conjunction with one or more of the other elements disclosed in FIG. 4, is an illustrative processing device, computing device or processing device as such terms are used within this disclosure. Read only memory (ROM) 410 and random access memory (RAM) 415 constitute illustrative memory devices (such as, for example, processing device-readable non-transitory storage media).

A controller 420 interfaces with one or more optional memory devices 425 to the system bus 400. These memory devices 425 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 410 and/or the RAM 415. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 430 may permit information from the bus 400 to be displayed on the display 435 in audio, visual, graphic, or alphanumeric format, such as the interface previously described herein. Communication with external devices, such as a print device, may occur using various communication ports 440. An illustrative communication port 440 may be attached to a communications network, such as the Internet, an intranet, or the like.

The hardware may also include an interface 445 which allows for receipt of data from input devices such as a keyboard 450 or other input device 455 such as a mouse, a joystick, a touch screen, a remote control, a pointing device, a video input device and/or an audio input device.

The hardware may also include a storage device 460 such as, for example, a connected storage device, a server, and an offsite remote storage device. Illustrative offsite remote storage devices may include hard disk drives, optical drives, tape drives, cloud storage drives, and/or the like. The storage device 460 may be configured to store data as described herein, which may optionally be stored on a database 465. The database 465 may be configured to store information in such a manner that it can be indexed and searched, as described herein.

The computing device of FIG. 4 and/or components thereof may be used to carry out the various processes as described herein.

### EXAMPLE

A patient is admitted with the following known covariates:

Gender Female

Age Elderly

Comorbid Conditions 4

Cognitively Intact Yes

Number of Prior Admissions 3

Local Poverty Level High

In this simplified case, the patient data may be obtained from survey responses (age, gender, and cognition), electronic health record data (comorbid conditions) historical information (prior utilization), and from outside sources (census data regarding local poverty levels). All risk-relevant data are passed to the risk assessment algorithm, all patient grouping data are passed to the classification & clustering algorithm, and so on. Each component of the software system may operate at least partially independent of the others, such that partial or missing data does not prevent an overall assessment from taking place. The patient's readmission risk may evaluate as high, which is communicated to the caregiver or case manager in the form of a relative risk scale. A different scoring algorithm altogether may determine the level of need for post-acute care, a precursor to a recommendation. Finally, via the classification portion of the software system, the patient's classification might recommend a specific type of post-acute care (for example, a Skilled Nursing Facility). This recommendation is also communicated to the caregiver/case manager.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method comprising:
receiving, by a processing device, admission data relating to a patient;
receiving, by the processing device, assessment information regarding the patient;
determining, by the processing device, a readmission risk score for the patient;
determining, by the processing device, a post-acute care recommendation for the patient based on the readmission risk score and one or more patient covariates; and
outputting, by the processing device, the post-acute care recommendation.

2. The method of claim 1, further comprising:
outputting, by the processing device, the readmission risk score; and
receiving, by the processing device, initial feedback regarding the readmission risk score prior to determining the post-acute care recommendation, wherein determining the post-acute care recommendation is further based on the initial feedback, and wherein the initial feedback comprises at least an initial recommendation or an alternate recommended option for the patient.

3. The method of claim 1, further comprising:
receiving, by the processing device, an outcome regarding post-acute care of the patient subsequent to outputting the post-acute care recommendation; and
updating, by the processing device, a database containing the assessment information.

4. The method of claim 1, wherein the one or more patient covariates comprise at least one of a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

5. The method of claim 1, wherein determining the readmission risk score comprises determining, by the processing device, a conditional probability of readmission based on a set of covariates relative to a population risk.

6. The method of claim 1, wherein determining the readmission risk score comprises determining the readmission risk score based on the patient's history and other patient outcomes.

7. A system comprising:
a processing device; and
a non-transitory, computer-readable storage medium in operable communication with the processing device, wherein the non-transitory, computer-readable storage medium comprises one or more programming instructions that, when executed, cause the processing device to:
receive admission data relating to a patient,
receive assessment information regarding the patient,
determine a readmission risk score for the patient,
determine a post-acute care recommendation for the patient based on the readmission risk score and one or more patient covariates, and
output the post-acute care recommendation.

8. The system of claim 7, wherein the non-transitory, computer-readable storage medium further comprises one or more programming instructions that, when executed, cause the processing device to:
output the readmission risk score; and
receive initial feedback regarding the readmission risk score prior to determining the post-acute care recommendation, wherein determining the post-acute care recommendation is further based on the initial feedback, and wherein the initial feedback comprises at least an initial recommendation or an alternate recommended option for the patient.

9. The system of claim 7, wherein the non-transitory, computer-readable storage medium further comprises one or more programming instructions that, when executed, cause the processing device to:
receive an outcome regarding post-acute care of the patient subsequent to outputting the post-acute care recommendation; and
update a database containing the assessment information.

10. The system of claim 7, wherein the one or more patient covariates comprise at least one of a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

11. The system of claim 7, wherein the one or more programming instructions that, when executed, cause the processing device to determine the readmission risk score comprises one or more programming instructions that, when executed, cause the processing device to determine a conditional probability of readmission based on a set of covariates relative to a population risk.

12. The system of claim 7, wherein the one or more programming instructions that, when executed, cause the processing device to determine the readmission risk score comprises one or more programming instructions that, when executed, cause the processing device to determine the readmission risk score based on the patient's history and other patient outcomes.

13. A computer program product comprising one or more programming instructions that, when executed by a processing device, cause the processing device to:
receive admission data relating to a patient;
receive assessment information regarding the patient;
determine a readmission risk score for the patient;
determine a post-acute care recommendation for the patient based on the readmission risk score and one or more patient covariates; and
output the post-acute care recommendation.

14. The computer program product of claim 13, further comprising one or more programming instructions that, when executed by the processing device, cause the processing device to:
output the readmission risk score; and
receive initial feedback regarding the readmission risk score prior to determining the post-acute care recommendation, wherein determining the post-acute care recommendation is further based on the feedback, and wherein the initial feedback comprises at least an initial recommendation or an alternate recommended option for the patient.

15. The computer program product of claim 13, further comprising one or more programming instructions that, when executed by the processing device, cause the processing device to:
receive an outcome regarding post-acute care of the patient subsequent to outputting the post-acute care recommendation; and
update a database containing the assessment information.

16. The computer program product of claim 13, wherein the one or more patient covariates comprise at least one of a patient's current cognition status, a patient's current walking ability, care availability at a patient's place of residence, a patient's self-assessed health rating, a number of co-morbid conditions, a depression screening status, a loss-of-pleasure screening status, a patient's length of stay, a patient's age, and a patient's income.

17. The computer program product of claim 13, wherein the one or more programming instructions that, when executed by the processing device, cause the processing device to determine the readmission risk score comprises one or more programming instructions that, when executed by the processing device, cause the processing device to determine a conditional probability of readmission based on a set of covariates relative to a population risk.

18. The computer program product of claim 13, wherein the one or more programming instructions that, when executed by the processing device, cause the processing device to determine the readmission risk score comprises one or more programming instructions that, when executed by the processing device, cause the processing device to determine the readmission risk score based on the patient's history and other patient outcomes.
